(19) United States
(12) Patent Application Publication
(10) Pub. No.: US 2025/0234225 A1
(43) Pub. Date: Jul. 17, 2025

(54) CONTROLLING OF QUALITY OF EXPERIENCE MEASUREMENT

(71) Applicant: NOKIA TECHNOLOGIES OY, Espoo (FI)

(72) Inventors: Jing HE, Beijing (CN); Malgorzata TOMALA, Wroclaw (PL)

(21) Appl. No.: 19/169,809

(22) Filed: Apr. 3, 2025

Related U.S. Application Data
(63) Continuation of application No. 18/553,647, filed on Oct. 2, 2023.

(51) Int. Cl. H04W 24/08

(52) U.S. Cl. CPC H04W 24/08

(57) ABSTRACT

Embodiments of the present disclosure relate to a method, device and computer readable storage medium of communication. The method implemented at a first device comprises: obtaining first periodicity information indicating a first periodicity. The first periodicity is used by a second device to perform a quality of experience measurement. The method further comprises determining a second periodicity to be used by an AS of the second device to report one or more measurement results of the QoE measurement. The method further also comprises transmitting second periodicity information indicating the second periodicity to the second device. In this way, the first device may be involved in the procedure of configuration and maintaining the QoE measurement. More specifically, the first device may control the interval for reporting QoE measurement results.

### CROSS-REFERENCE TO RELATED APPLICATIONS

This application is a continuation of U.S. application Ser. No. 18/553,647, filed Oct. 2, 2023, which is a national phase entry of International Application No. PCT/CN2021/085058, filed Apr. 1, 2021, the entire contents of which are incorporated herein by reference.

### FIELD

Embodiments of the present disclosure generally relate to the field of telecommunication and in particular, to devices, methods and computer readable storage media for controlling of quality of experience (QoE) measurement.

### BACKGROUND

The QoE measurement results indicate objective experience of a user on the satisfaction of communication service(s) in an application (APP) layer. As a result, it usually used as one of the key indicators for evaluating and assessing the quality of the communication service(s). Further, a service provider or an operator may obtain the quality of the communication service(s) by collecting the measurement results (also referred to as “QoE metrics” sometimes) from a terminal device of the user, and improve the quality of corresponding communication service(s) according to the collected measurement results.

In wireless communication, a core network (CN) device or an operation administration and maintenance (OAM) device receives the QoE measurement configuration from an application server, and further transmits the QoE measurement configuration to the terminal device via an access network device. After receiving the QoE measurement configuration, an APP layer of the terminal device will perform the QoE measurement and convey the measurement results to an access layer/stratum of the terminal device. The measurement results will be processed and transmitted to the access network device, and the access network device will forward the measurement results to the CN/OAM device. During the above procedure, the access network device merely functions as a forwarding device between the terminal device and the CN/OAM device. However, in some scenarios (such as, the access network device is in an overload situation), the access network device has requirements to adjust or control the QoE measurement. Therefore, it is desirable that the access network device may be involved in the procedure of configuration and maintaining the QoE measurement.

### SUMMARY

In general, example embodiments of the present disclosure provide a solution for controlling of QoE measurement.

In a first aspect, there is provided a first device. The first device comprises at least one processor; and at least one memory including computer program code; where the at least one memory and the computer program code are configured to, with the at least one processor, cause the first device to obtain first periodicity information indicating a first periodicity used by a second device to perform a quality of experience measurement; determine a second periodicity to be used by an access stratum of the second device to report one or more measurement results of the quality of experience measurement; and transmit second periodicity information indicating the second periodicity to the second device.

In a second aspect, there is provided a second device. The second device comprises at least one processor; and at least one memory including computer program code; where the at least one memory and the computer program code are configured to, with the at least one processor, cause the second device to receive, from a first device, second periodicity information indicating a second periodicity to be used by an access stratum of the second device to report one or more measurement results of a quality of experience measurement, the second periodicity configured based on a first periodicity used by the second device to perform the quality of experience measurement; collect, by the access stratum of the second device, the one or more measurement results of the quality of experience measurement measured by an application layer of the second device; and report, by the access stratum of the second device, the one or more measurement results according to the second periodicity.

In a third aspect, there is provided a third device. The third device comprises at least one processor; and at least one memory including computer program code; where the at least one memory and the computer program code are configured to, with the at least one processor, cause the third device to obtain a first periodicity used by a second device to perform a quality of experience measurement; and transmit, to a first device, a message comprising the first periodicity, the first periodicity transmitted in a manner that is identifiable relative to access stratum.

In a fourth aspect, there is provided a method. The method comprises obtaining, at a first device, first periodicity information indicating a first periodicity used by a second device to perform a quality of experience measurement. The method further comprises determining a second periodicity to be used by an access stratum of the second device to report one or more measurement results of the quality of experience measurement. The method also comprises transmitting second periodicity information indicating the second periodicity to the second device.

In a fifth aspect, there is provided a method. The method comprises receiving, at a second device and from a first device, second periodicity information indicating a second periodicity to be used by an access stratum of the second device to report one or more measurement results of a quality of experience measurement, the second periodicity configured based on a first periodicity used by the second device to perform the quality of experience measurement. The method further comprises collecting, by the access stratum of the second device, the one or more measurement results of the quality of experience measurement measured by an application layer of the second device. The method also comprises reporting, by the access stratum of the second device, the one or more measurement results according to the second periodicity.

In a sixth aspect, there is provided a method. The method comprises obtaining, at a third device, a first periodicity used by a second device to perform a quality of experience measurement. The method further comprises transmitting, to a first device, a message comprising the first periodicity, the first periodicity transmitted in a manner that is identifiable relative to access stratum.

In a seventh aspect, there is provided a first apparatus. The first apparatus comprises means for obtaining, at a first apparatus, first periodicity information indicating a first periodicity used by a second apparatus to perform a quality of experience measurement; The first apparatus further comprises means for determining a second periodicity to be used by an access stratum of the second apparatus to report one or more measurement results of the quality of experience measurement. The first apparatus also comprises means for transmitting second periodicity information indicating the second periodicity to the second apparatus.

In an eighth aspect, there is provided a second apparatus. The second apparatus comprises means for receiving, at a second apparatus and from a first apparatus, second periodicity information indicating a second periodicity to be used by an access stratum of the second apparatus to report one or more measurement results of a quality of experience measurement, the second periodicity configured based on a first periodicity used by the second apparatus to perform the quality of experience measurement. The second apparatus further comprises means for collecting, by the access stratum of the second apparatus, the one or more measurement results of the quality of experience measurement measured by an application layer of the second apparatus. The second apparatus also comprises means for reporting, by the access stratum of the second apparatus, the one or more measurement results according to the second periodicity.

In ninth aspect, there is provided a third apparatus. The third apparatus comprises means for obtaining, at a third apparatus, a first periodicity used by a second apparatus to perform a quality of experience measurement. The third apparatus further comprises means for transmitting, to a first apparatus, a message comprising the first periodicity, the first periodicity transmitted in a manner that is identifiable relative to access stratum.

In a tenth aspect, there is provided a computer readable medium. The computer readable medium comprises program instructions for causing an apparatus to perform at least the method according to the fourth aspect.

In an eleventh aspect, there is provided a computer readable medium. The computer readable medium comprises program instructions for causing an apparatus to perform at least the method according to the fifth aspect.

In a twelfth aspect, there is provided a computer readable medium. The computer readable medium comprises program instructions for causing an apparatus to perform at least the method according to the sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a conventional signaling flow of QoE configuration and reporting procedure;

FIG. 2 illustrates an example communication network in which example embodiments of the present disclosure may be implemented;

FIG. 3 illustrates a signaling flow of controlling of QoE measurement according to some embodiments of the present disclosure;

FIG. 4 illustrates another signaling flow of controlling of QoE measurement according to some embodiments of the present disclosure;

FIG. 5 illustrates a flowchart of an example method performed at the first device according to some embodiments of the present disclosure;

FIG. 6 illustrates a flowchart of an example method performed at the second device according to some embodiments of the present disclosure;

FIG. 7 illustrates a flowchart of an example method performed at the third device according to some embodiments of the present disclosure;

FIG. 8 illustrates a simplified block diagram of a device that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “core network device” refers to any device or entity that provides access and mobility management function (AMF), session management function (SMF), user plane function (UPF), etc. By way of example rather than limitation, the core network device may be a home subscriber server (HSS), a mobility management entity (MME), an AMF, a SMF, a UPF, etc. In other embodiments, the core network device may be any other suitable device or entity.

The term “OAM device” refers to any device or entity that provides functions, such as, operation, administration and maintenance, and the likes. By way of example rather than limitation, the OAM device may be a network management system (NMS) or a network element management system (EMS). In other embodiments, the core network device may be any other suitable device or entity.

The term “being identifiable relative to access stratum” refers to an access stratum of a device in the communication network can identify the related data/information. Terms “access layer”, “access stratum” and “radio resource control (RRC) layer” as used herein are equivalent with each other.

The term “being identifiable relative to APP layer” refers to merely an APP layer of a device in the communication network can identify the related data/information. The term “APP layer” can be also referred as “application layer” or “higher layer” in the disclosure.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As discusses above, the procedure of QoE measurement is desirable to be improved. A work item (WI) was conducted in the third Generation Partnership Project (3GPP) for QoE measurement in New Radio (NR). As results of that work, some QoE solutions are proposed and stipulated from RAN2 point of view. More specifically, the following QoE solutions are specified for NR:

Signalling-based procedure: the CN device initiates the activation of the QoE measurement configured by OAM, and sends the QoE measurement configuration to a next generation radio access network (NG-RAN) node. The NG-RAN node further passes the QoE measurement configuration towards a specific UE via RRC Signalling. The access stratum (AS) of the UE (such as, RRC layer) sends the QoE measurement configuration to an APP layer of the UE.

Management-based procedure, the OAM device sends the QoE measurement configuration to the NG-RAN node. The NG-RAN node determines multiple qualified UEs that meet the criteria (such as, area scope, application layer capability, service type, and the likes) or a single specific UE. The NG-RAN node sends the QoE measurement configuration to the AS layer of the specific UE or each qualified UE. Upon receiving the QoE measurement configuration, the AS of the UE sends the QoE measurement configuration to the APP layer of the UE.

A QoE data collection procedure is the central procedure of the QoE measurement procedure. Generally speaking, the QoE data collection refers to a method to use radio protocols for collection of QoE metrics developed for Download and Dynamic Adaptive Streaming over HTTP (DASH). Some agreements have been reached for a LTE QoE solution. For example, the LTE QoE solution includes the following key parts:
Both signalling-based and management-based initiated cases are allowed;
The LTE QoE feature is activated by trace function.

APP layer measurement configuration received from OAM or CN can be encapsulated in a transparent container, which is forwarded to UE in a downlink RRC message. APP layer measurement results received from a higher layer of the UE (such as, APP layer) can be encapsulated in a transparent container and sent to network in an uplink RRC message.

As for NR QoE, it takes the LTE QoE solution as baseline and details can be discussed during the WI phase. Further, some principles of configuration and reporting for the QoE measurement are also proposed. Specifically, management-based QoE configuration should not override signaling-based QoE configuration. Further, QoE measurement results are reported via a separate signaling radio bearer (SRB) (i.e., separate from current SRBs) in NR, because this reporting has a lower priority than that of other SRB transmissions. Finally, configuration and reporting for multiple simultaneous QoE measurements for a UE should be supported.

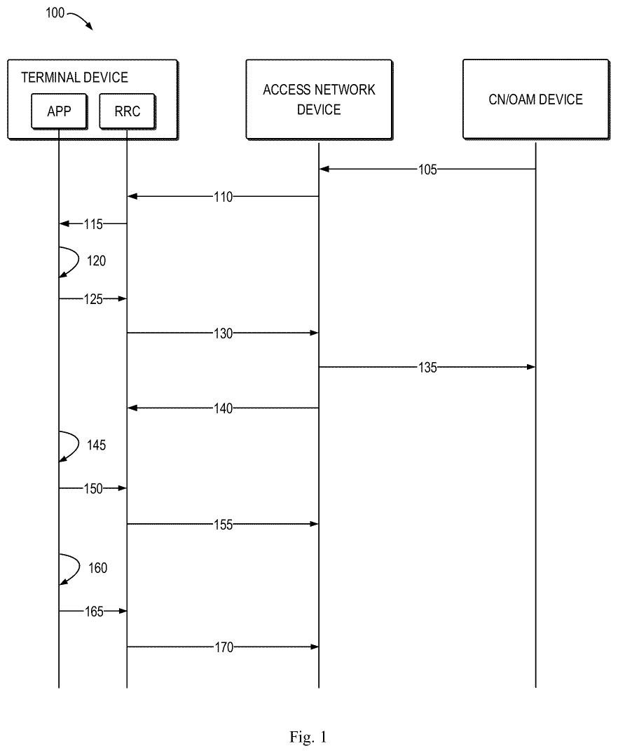

Reference is now made to FIG. 1, which is a conventional signaling flow 100 of QoE configuration and reporting procedure. As shown in FIG. 1, the CN/OAM transmits 105 the QoE measurement configuration to the gNB, where the QoE measurement configuration is XML formatted. The gNB determines the associated UE and transmits 110 the QoE measurement configuration to the UE RRC via one application layer container. The QoE parameters comprised in the QoE measurement configuration are transparent for the gNB and the RRC layer of the UE. The QoE parameters are transmitted 115 to the UE APP layer (i.e., UE APP entity) via an AppLayerConfiguration Service type. The UE APP layer determines 120 the QoE measurement is available, and then transmits 125 the measurement results to the UE RRC layer (i.e., UE RRC entity). The UE RRC layer transmits 130 the measurement results to the gNB via an AppLayerMeasReport container, and the gNB forward 135 the measurement results to the CN/OAM device.

During the above conventional procedure, the QoE measurement configuration is XML formatted. Therefore, only the APP layer of the UE can understand the QoE parameters (such as, an interval for reporting the measurement results) comprised in the QoE measurement configuration. After obtaining the QoE parameter, the UE APP layer may report QoE data/metrics (i.e., measurement results) with a periodicity defined in the QoE measurement configuration.

As discussed above, since the QoE parameters are sent transparently to the gNB and the UE RRC layer, neither the gNB nor the UE RRC layer can obtain the QoE parameters. Therefore, both the gNB and the UE RRC layer cannot know the exact time points for reporting the measurement results.

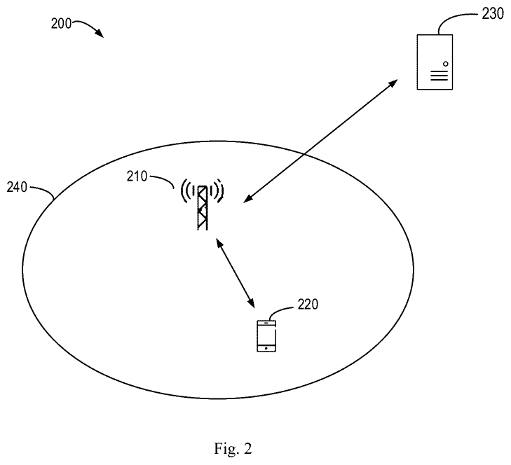

The actual communication environment is very complicated. The gNB being overload is a common scenario. According to a conventional procedure, when the gNB is in an overload situation, the gNB may release air interface connections (such as, RRC connections). As shown in FIG. 2, the gNB may transmit 140 a RRC release message to the UE RRC layer. The operation of releasing the RRC connection will affect the QoE measurement. For example, new QoE measurement configurations are stopped and the reporting of the ongoing QoE measurement is released or paused in the RRC layer of the UE.

However, the operation of releasing the RRC connection will not be informed to the UE APP layer. Therefore, the effect of pausing the QoE measurement happens merely in RRC layer. Therefore, it creates a problem with configuration left ongoing in the application level. More specifically, as shown in FIG. 1, after the receiving the RRC release message, the UE APP layer determines 145 that the QoE measurement is available, and then transmits 150 the measurement results to the UE RRC. However, as the RRC connection has been released by the UE RRC layer, the measurement results cannot be transmitted 155 to the gNB. In the next procedure, the UE APP layer determines 160 the QoE measurement is available again, and then transmits 165 the measurement results to the UE RRC layer. The measurement results still cannot be transmitted 170 to the gNB. The above failure transmission will be repeated. In this event, the UE APP layer will generate storm of reports which cannot be transmitted to the gNB due to lacking active RRC connection.

So far, no solution about how to pause/resume QoE measurement reporting in context of different RRC states has been proposed, which brings about additional complexities in handling unexpected QoE measurement results generated by the UE APP layer. In addition, as discussed above, the measurement results of QoE are important for the service provider or operator. Therefore, pausing or stopping the QoE measurement is also not considered to be a desirable result.

The present discourse notes that if an access network device can control or maintain of the QoE measurement, especially can configure the reporting procedure, the QoE measurement procedure may be more flexible and reasonable.

In accordance with some example embodiments of the present disclosure, there is provided a solution for controlling of QoE measurement. In this solution, the first device (such as, an access network device) obtains first periodicity information indicating a first periodicity. The first periodicity is used by a second device (such as, a terminal device) to perform a QoE measurement. Then the first device determines a second periodicity to be used by an AS (such as, RRC layer) of the second device to report one or more measurement results of the QoE measurement and transmits second periodicity information indicating the second periodicity to the second device. In this way, the first device may be involved in the procedure of configuration and maintaining of the QoE measurement. In particular, the first device may control the interval/cycle for reporting QoE measurement results. The present disclosure especially benefits the scenario that the first device is in an overload situation.

FIG. 2 shows an example communication environment 200 in which example embodiments of the present disclosure can be implemented. In the communication environment 100, a first device 210 can communicate with a second device 220 and a third device 230 via physical communication channels or links.

In the example of FIG. 2, the second device 220 is illustrated as terminal device. The first device 210 is illustrated as access network device serving the second device 220. the serving area of the first device 210 is called as cell 240. The third device 230 is illustrated as a QoE measurement server. The third device 230 may be a CN device, an OAM device or an application server.

In the specific example of FIG. 2, the third device 230 may obtain or configure parameters for QoE measurement. Then, the third device 230 may transmit the parameters to the first device 210. The first device 210 may forward the parameters to the second device 220. After receiving the parameters, the APP layer of the second device 220 performs the QoE measurement and transmits the measurement results to the AS (such as, RRC layer) of the second device 220. The measurement results may be transmitted to the first device 210 by the AS of the second device 220 and then be forwarded to the third device 230 or other QoE collection server(s) by the first device 210.

It is to be understood that the numbers of first device, second device and third device are only for the purpose of illustration without suggesting any limitations. The communication environment 200 may include any suitable numbers of first device, second device and third device adapted for implementing embodiments of the present disclosure.

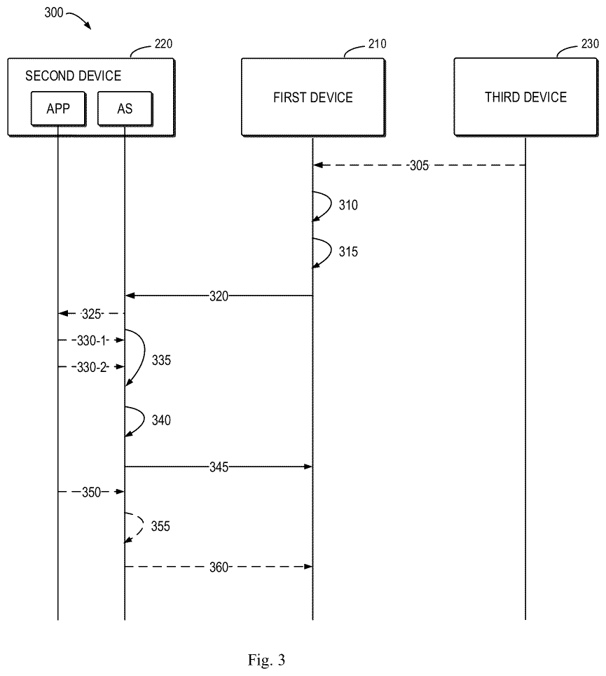

Principle and implementations of the present disclosure will be described in detail below with reference to FIG. 3, which shows example signaling charts 300 for the method for controlling QoE measurement in accordance with some embodiments of the present disclosure. The method may be implemented at any suitable devices according to the specific implements.

Only for the purpose of illustrations, the signaling charts 300 are described to be implemented between the first device 210, the second device 220 and the third device 230 as shown in FIG. 2. Further, the second device 220 functions as a terminal device, the first device 210 functions as an access network device and the third device 230 functions as a CN device, an OAM device or an application server.

Further, in the following, while operations are depicted in a particular order, this should not be understood as requiring that such operations be performed in the particular order shown or in sequential order, or that all illustrated operations be performed, to achieve desirable results.

Additionally, the third device 230 may obtain or configure the parameters for QoE measurement, such that the service provider or operator in the network system may collect one or more measurement results from one or more user devices (e.g., terminal devices). More specifically, the third device 230 may configure a periodicity (referred to as “first periodicity” herein), where the first periodicity may be a duration for collecting the measurement results or a cycle for reporting measurement results.

In addition, the first periodicity may be represented in any suitable manner. In some example embodiment, the first periodicity may be represented as parameter @reportinginterval. The @reportinginterval indicates the time point(s) that the measurement reports should be sent. Further, if the @reportinginterval is not configured, the second device 220 should send a report comprising the measurement results after the streaming session has ended. If the @reportinginterval is configured, the second device 220 should send a report the measurement results according to the @reportinginterval. Further, for each report sent by the second device 220, only the newly collected measurement results are comprised, since the previous measurement results have been reported. According to some of the example embodiments of the present discourse, the first periodicity configured by the third device 230 may be hijacked by a second periodicity configured by the first device 210 as discussed as below.

The third device 230 may transmit 305 the parameters to the first device 210 via a configuration (for example, a configuration message or a configuration information element). In some example embodiments, the configuration may be represented as XML formatted file/data or an application-based container. Then, the first device 210 may transmit 320 an application layer container comprising the configuration to the access stratum AS (i.e., the RRC layer or the access stratum) of the second device 220. At the second device 220, the parameters comprised in the application layer container will be transmitted 325 from the AS to the APP layer of the second device 220. In this way, the second device 220 may perform a QoE measurement according to the configuration.

In some example embodiments, the first device 210 obtains 310 first periodicity information that indicates the first periodicity. The first device 210 may obtain the first periodicity information by any suitable manner. As an example embodiment, the first device 210 may decode the first periodicity information from the above-mentioned configuration transmitted by a third device 230. As discussed above, the configuration is identifiable relative to APP layer and used to configure the quality of experience measurement. Therefore, upon receiving the configuration, the first device 210 needs to decode the configuration. In this way, the first device 210 may obtain the first periodicity without exchanging any extra messages with other device.

Alternatively, or in addition, the first device 210 may extract the first periodicity information from a message 305 transmitted by the third device 230, where the first periodicity information is transmitted in a manner that is identifiable relative to access stratum (i.e., the RRC layer or the access layer). For example, the third device 230 may transmit the first periodicity information via an information element (IE). The IE comprising the first periodicity information may be transmitted together with the configuration. Alternatively, the IE may be transmitted separately from the configuration. For example, the third device 230 transmits 305 the IE in response to a request from the first device 210. In this way, the first device 210 may obtain the first periodicity without requiring adding any extra capability of decoding the APP layer container to the first device 210.

Alternatively, or in addition, the first device 210 may extract the first periodicity information from the second device 220. More specifically, the second device 220 may transmit a RRC message comprising the first periodicity information. In some example embodiments, the second device 220 may transmit the RRC message once the second device 220 obtains the first periodicity. Alternatively, the second device 220 may transmit the RRC message in response to a request from the first device 210. In this way, the first device 210 may obtain the first periodicity without requiring adding any extra capability of decoding APP layer container to the first device 210.

Alternatively, or in addition, the first device 210 may obtain the first periodicity information based on statistics of the measurement results reported from the second device 220. As an example, the second device 220 may derive the interval between the measurement results reported by the second device 220, and may equate the interval to the first periodicity. In this way, the first device 210 may obtain the first periodicity without exchanging any extra messages with other device.

It is to be understood that the above examples for obtaining the first periodicity information are given for the purpose of illustration without suggesting any limitations. In other example embodiments, the first device 210 may obtain the first periodicity information by any suitable manner.

After obtaining the first periodicity information, the first device 210 may determine 315 a second periodicity. The second periodicity is to be used by an AS (such as, RRC layer) of the second device 220 to report the measurement results of the QoE measurement. In some example embodiments, the second periodicity is longer than the first periodicity. Further, when the second periodicity is enabled (i.e., applied by the second device 220), the first periodicity will be hijacked by the second periodicity when the second device 220 reports the measurement results. The first device 210 then transmits 320 second periodicity information indicating the second periodicity to the second device 220.

In some example embodiments, in case that the first periodicity is not present, the first device 210 sets its own parameter for reporting QoE measurements (i.e., the second periodicity) and transmits the second periodicity to the second device 220 as a RAN-triggered additional parameter.

In some example embodiments, the first device 210 may transmit the second periodicity information together with the application layer container comprising the configuration comprising the parameters for QoE measurement. Alternatively, the first device 210 may transmit the second periodicity information when the first device 210 determines that the first device 210 is in an overload situation.

In addition, the first device 210 may instruct the second device 210 whether to apply the second periodicity to the second device 220 or not. In some example embodiments, the second periodicity information may be used as an implicit indication to instruct the second device 220 to apply the second periodicity. Alternatively, the first device 210 may transmit a first request to the second device 220 as an explicit manner. The first request is used to instruct the second device 220 to apply the second periodicity when reporting the one or more measurement results. In addition, the first device 210 may transmit the first request when the first device 210 determines that the first device 210 is in an overload situation.

In addition, the second periodicity information may indicate the second periodicity through any suitable manner. One example of the second periodicity information is a value of the second periodicity. Another example of the second periodicity information is an offset value indicating a time difference between the second periodicity and the first periodicity. Further example of the second periodicity information is a scale factor of the second periodicity relative to the first periodicity.

It is to be understood that the above examples of second periodicity information are given for the purpose of illustration without suggesting any limitations. In other example embodiments, the first device 210 may indicate the second periodicity by any suitable manner.

In this way, the first device 210 may configure a periodicity used by the AS of the second device 220 for reporting the measurement results. Therefore, even if the first device 210 is in an overload situation, the first device 210 does not necessarily stop or pause the ongoing QoE measurement directly.

In addition, the first device 210 may determine the second periodicity per service. In other words, the second periodicity is specific to at least one service. In this event, the first device 210 also transmits an indication of at least one service of the second device 220 together with the second periodicity information.

In this way, different services of the second device 220 may be configures with different second periodicities. Thus, the QoE of different services may be controlled more flexibly.

Alternatively, or in addition, the second periodicity is a common periodicity shared among a plurality of services served by the network. More specifically, the different services may be configured with different first periodicities, and the first device 210 may determine a common second periodicity that is longer than the longest periodicity of the different first periodicities.

In addition, the first device 210 may transmit more than one second periodicity to the second device 220 in one message or a plurality of messages. The second device 220 may apply the more than one second periodicity according any suitable pre-defined strategy.

In some example embodiments, the first device 210 transmits the second periodicity information via a system information block (SIB). Alternatively, the first device 210 transmits the second periodicity information via a RRC message. It is to be understood that the second periodicity can be transmitted to the second device 220 in a broadcast manner, multicast manner or unicast manner.

In some example embodiments, the first device 210 may also indicate the second device 220 to resume applying the first periodicity. Specially, the first device 210 transmits a second request to the second device 220 when the first device 210 determines that the first device 210 is in a non-overload situation. The second request is used to instruct the second device 220 to to resume applying the first periodicity when reporting the one or more measurement results.

In addition, the first device 210 may transmit an load indication indicating the load state of the first device 210 to the second device 220, and the second device 220 may determine whether to apply the second periodicity or the first periodicity based on the load indication of the first device 210.

In this way, the first device 210 may adjust the periodicity for reporting the measurement reports dynamically.

In the specific example FIG. 2, the APP layer of the second device 220 performs QoE measurement, which may be represented as QoE metrics. The measurement results are transmitted to the AS layer of the second device 220. More specifically, the APP layer transmits 330-1 and 330-2 the measurement results to the AS of the second device 220. The AS of the second device 220 collects 335 the one or more measurement results and reports the one or more measurement results to the first device 210. Further, the measurement results are transmitted in a manner that is identifiable relative to APP layer. For example, the measure result in comprised in an application-based container.

If the second device 220 is configured with the second periodicity, when reporting the measurement results, the second device 220 may start a timer according to the second periodicity. Within the timer, the second device 220 appends each of the measurement results to a measurement log. Upon the timer is timeout, the second device 220 reports 345 the measurement log to the first device 210.

In this way, the frequency/interval of reporting the measurement results is reduced, which saves resource of air interface between the first device 210 and the second device 220 thereby.

In addition, the second device 220 may determine whether to apply the second periodicity or the first periodicity according to some pre-defined criterion.

In some example embodiments, the second device 220 first determines 340 whether a condition for applying the second periodicity is met or not, and then determines whether to apply the second periodicity or not. One example of the condition is receiving the second periodicity information from the first device 210. Another example of the condition is receiving a first request to apply the second periodicity from the first device 210. In this case, the first request is acting as a trigger. That is, after receiving the configuration including the second periodicity information, the second device applies the second periodicity based on the configuration when the first request is received. Further example of the condition is determining that the first device 210 is in an overload situation. Specifically, the second device 220 may detect the communications between the first device 210 and the second device 220 causing the second device 220 to back off or to be released due to the load condition detection of the first device 210. The second device 220 may detect the load condition of the first device 210 by any suitable manner, for example, by detecting channel conditions, status of a local buffer, a rate of uplink/downlink transmissions, a connection release, and the likes. Alternatively, the second device 220 may receive the load indication from the first device 210 to obtain the load information of the first device 210. Specifically, when the first device 210 is in the overload situation, the first device may transmit an overload indicator to the second device 220, initiate procedures of releasing RRC connections, refuse a new random access request or an attach request, and the likes.

It should be understood that the above conditions for applying the second periodicity are given for the purpose of illustration without suggesting any limitations. The second device 220 may apply any suitable condition for determining whether to apply the second periodicity or not.

In addition, in some example embodiments, the second device 220 first determines 340 whether a condition resuming applying the first periodicity is met or not, and then determines whether to resume applying the first periodicity or not. One example of the condition is receiving a second request to resume applying the first periodicity from the first device 210. Another example of the condition is determining the first device 210 is in a non-overload situation. The second device 220 may detect the load condition of the first device 210 by any suitable manner, for example, by detecting channel conditions, status of a local buffer, a rate of uplink/downlink transmissions, a connection release, and the likes. Further example of the condition is the second device 220 receives a new configuration to be used for performing QoE measurement without receiving a configured second periodicity.

If the second device 220 determines 355 that the condition for resuming applying the first periodicity is met, the AS of the second device 220 reports the measurement results according to the first periodicity. More specifically, the APP layer of the second device 220 transmits 350 the measurement result to the AS of the second device 220, and the AS of the second device 220 reports 360 the measurement result to the first device 210 according to the first periodicity, which may be implemented by using a timer corresponding to the first periodicity.

In addition, as discussed above, the second periodicity may be specific to the at least one service. Therefore, the second device 220 may receive a plurality of the second periodicities. In this event, the second device 220 performs the QoE measurements of different service independently. Alternatively, the second device 220 may divide the different services into multiple service groups according to the plurality of the second periodicities, and then performs the QoE measurements per service group. In one example embodiment, the second device 220 receives a second periodicity that is specific to the at least one service. Then, the second device 220 apples the second periodicity to the at least one service and reports the measurement results of at least one service according to the second periodicity.

In this way, the measurement results collected within the second periodicity may be transmitted via a RRC message as one report, such that the efficiency for reporting the measurement is improved.

Alternatively, or in addition, the second periodicity also may be is the common periodicity shared among a plurality of services by the second device 220. In one example embodiment, the second device 220 receives a common second periodicity. Then, the second device 220 applies the second periodicity to a plurality of services and reports the measurement results of the plurality of services according to the second periodicity.

It is to be understood that the second device 220 may receive a plurality of second periodicities, and each of the plurality of second periodicity may be either a service-specific second periodicity or a common second periodicity. The second device 220 may apply the plurality of second periodicities according to any pre-defined strategy.

The measurement results are transmitted to a QoE collection server by the first device 210. The QoE collection server may be a CN device, an OAM device or other application server in the communication network.

In this way, the first device 210 may be involved in the procedure of configuration and maintaining of the QoE measurement. In particular, the first device 210 may control the interval for reporting QoE measurement results. The present disclosure especially benefits the scenario that the first device 210 is in an overload situation.

Further, according to the embodiments of the present disclosure, compared with conventional solution, the controlling of the QoE measurement are more flexible when the first device 210 is in an overload situation. During the procedure of QoE measurement, the QoE reporting cycle may be adjusted to be longer cycle. Thus, the load of the first device 210 can be relieved without interrupting the QoE measurements. In addition, it also avoids frequently transmitting Pause/Resume commands to the second device 220, such that the signalling resource in air interface is further saved.

### One Specific Example for Controlling of QoE Measurement

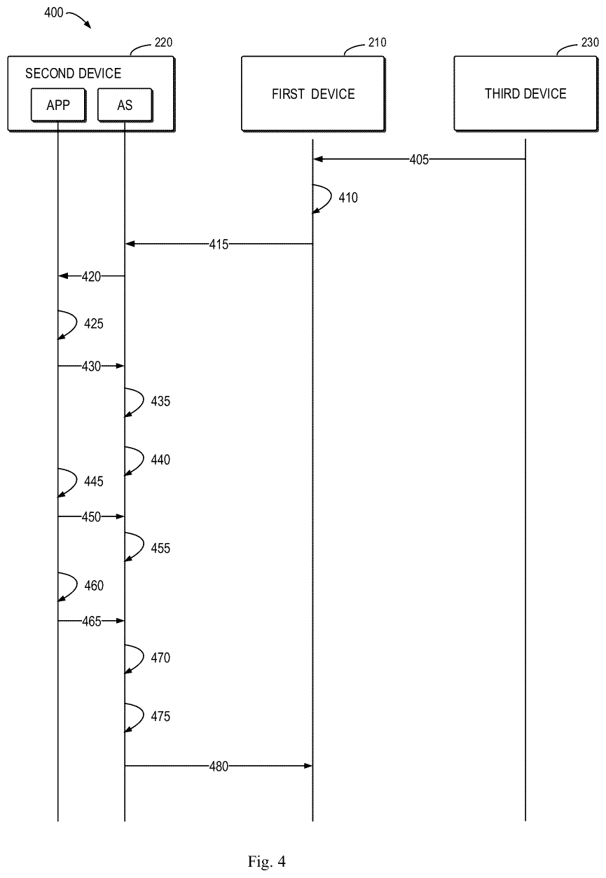

FIG. 4 shows example signaling charts 400 for the method of controlling QoE measurement. Only for the purpose of illustrations, the signaling charts 400 are described to be implemented between the first device 210, the second device 220 and the third device 230 as shown in FIG. 2. Further, the second device 220 functions as a terminal device, the first device 210 functions as an access network device and the third device 130 functions as a CN device, an OAM device or an application server.

The third device 230 determines the parameters for QoE measurement and transmits 405 the parameters to the first device 210. One of the parameters is the first periodicity (such as, @reportinginterval). For example, the third device 230 transmits a QoE Measurement Configuration including the parameters for QoE to the first device 210. Further, the QoE Measurement Configuration is represented as XML formatted data/information/file or application-based container. Alternatively, or in addition, the first periodicity also may be transmitted in a manner that is identifiable relative to access stratum of the network entities.

The first device 210 decodes or extracts 410 the first periodicity (such as, @reportinginterval) from the received QoE Measurement Configuration. The first device 210 then determines one or more second periodicities based on the first periodicity. Then, the first device 210 transmits 415 an application container (such as, AppLayerConfiguration) to the AS (such as, RRC layer) of the second device 220. The application container may comprise one or more second periodicities, such as, a service-specific second periodicity (for example, a Report Interval per service), and/or a common second periodicity (for example, a logging duration per session, or a reporting periodicity per session).

The AS of the second device 220 transmits 420 the QoE parameters to the APP layer via such as an AppLayerConfiguration Service type. The APP layer of the second device 220 determines 425 the QoE measurement is available, and then transmits 430 the measurement results to the AS of the second device 220. The AS of the second device 220 creates 435 a measurement log for logging the received measurement result and starts 440 a timer according to the second periodicity. The measurement log may be stored in an internal storage of the second device 220.

Next, the APP layer of the second device 220 determines 445 the QoE measurement is available again, and then transmits 450 the measurement results to the AS of the second device 220. As the timer is not timeout, the AS of the second device 220 appends 455 the measurement results to the measurement log. The application layer of the second device 220 continues to perform the QoE measurement. As shown in FIG. 4, the APP layer of the second device 220 determines 460 the QoE measurement is available, and then transmits 465 the measurement results to the AS of the second device 220. As the timer is still not timeout, the AS of the second device 220 appends 470 the measurement results to the measurement log. After that, the AS of the second device 220 determines 470 whether the timer is timeout or not. If the second device 220 determines that the timer is timeout, the AS of the second device 220 report 480 the measurement log including the one or more measurements to the first device 210.

In this way, the first device 210 may control the interval for reporting QoE measurement results.

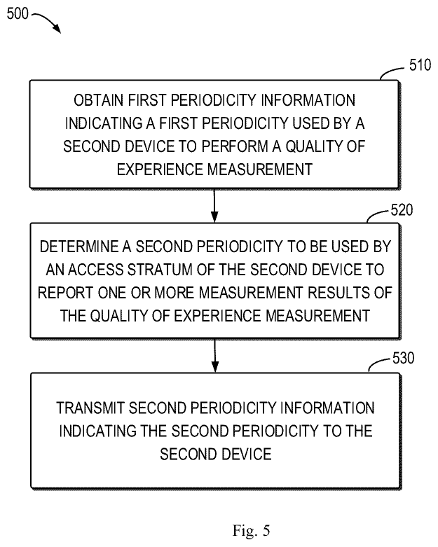

FIG. 5 shows a flowchart of an example method 500 implemented at a first device 210 in accordance with some example embodiments of the present disclosure. For the purpose of discussion, the method 500 will be described from the perspective of the first device 210 with respect to FIGS. 2 and/or 4. It is to be understood that the method 500 may include additional blocks not shown and/or may omit some shown blocks, and the scope of the present disclosure is not limited in this regard.

At block 510, the first device 210 obtains, at a first device 210, first periodicity information indicating a first periodicity used by a second device 220 to perform a quality of experience measurement.

At block 520, the first device 210 determines a second periodicity to be used by an access stratum of the second device 220 to report one or more measurement results of the quality of experience measurement; and

At block 530, the first device 210 transmits second periodicity information indicating the second periodicity to the second device 220.

In some example embodiments, the first device 210 obtains the first periodicity information comprises obtaining the first periodicity information by at least one of the following: decoding the first periodicity information from a configuration transmitted by a third device 230, the configuration being identifiable relative to an application layer and used to configure the quality of experience measurement; extracting the first periodicity information from a message transmitted by the third device 230, the first periodicity information transmitted in a manner that is identifiable relative to the access stratum; extracting the first periodicity information from a radio resource control message transmitted by the second device 220; or obtaining the first periodicity information based on statistics of the one or more measurement results reported from the second device 220.

In some example embodiments, the first device 210 receives, from the third device 230, a configuration used to configure the quality of experience measurement. Further, the first device 210 transmits an application layer container comprising the configuration to the second device 220 together with the second periodicity information.

In some example embodiments, the first device 210 transmits the second periodicity information in accordance with a determination that the first device 210 is in an overload situation.

In some example embodiments, the first device 210 transmits to the second device 220 a first request to apply the second periodicity when reporting the one or more measurement results in accordance with a determination that the first device 210 is in an overload situation.

In some example embodiments, the first device 210 transmits to the second device 220 a second request to resume applying the first periodicity when reporting the one or more measurement results in accordance with a determination that the first device 210 is in a non-overload situation

In some example embodiments, the first device 210 transmits an indication of at least one service of the second device 220, the second periodicity being specific to the at least one service.

In some example embodiments, the second periodicity is a common periodicity shared among a plurality of services by the second device 220.

In some example embodiments, the indication of the second periodicity comprises at least one of the following: a value of the second periodicity, an offset value indicating a time difference between the second periodicity and the first periodicity, or a scale factor of the second periodicity relative to the first periodicity.

In some example embodiments, the first device 210 the second periodicity information is transmitted via a system information block or a radio resource control message.

In some example embodiments, the second periodicity is longer than the first periodicity.

In some example embodiments, the first device 210 the first periodicity is configured by a third device 230, and wherein the third device 230 is a core network device or an operation administration and maintenance device.

In some example embodiments, the first device 210 is an access network device, and the second device 220 is a terminal device comprising the access stratum and an application layer.

A first apparatus capable of performing the method 500 may comprise means for performing the respective operations of the method 500. The means may be implemented in any suitable form. For example, the means may be implemented in a circuitry or software module. The first apparatus may be implemented as or included in the first device 210.

In some example embodiments, the first apparatus comprises means for obtaining, at a first apparatus, first periodicity information indicating a first periodicity used by a second apparatus to perform a quality of experience measurement; means for determining a second periodicity to be used by an access stratum of the second apparatus to report one or more measurement results of the quality of experience measurement; and means for transmitting second periodicity information indicating the second periodicity to the second apparatus.

In some example embodiments, means for obtaining the first periodicity information comprises means for obtaining the first periodicity information by at least one of the following: decoding the first periodicity information from a configuration transmitted by a third apparatus, the configuration being identifiable relative to an application layer and used to configure the quality of experience measurement; extracting the first periodicity information from a message transmitted by the third apparatus, the first periodicity information transmitted in a manner that is identifiable relative to an access stratum; extracting the first periodicity information from a radio resource control message transmitted by the second apparatus; or obtaining the first periodicity information based on statistics of the one or more measurement results reported from the second apparatus.

In some example embodiments, the first apparatus further comprises means for receiving, from the third apparatus, a configuration used to configure the quality of experience measurement; and means for transmitting an application layer container comprising the configuration to the second apparatus together with the second periodicity information.

In some example embodiments, means for transmitting the second periodicity information comprises means for in accordance with a determination that the first apparatus is in an overload situation, transmitting the second periodicity information.

In some example embodiments, the first apparatus further comprises means for in accordance with a determination that the first apparatus is in an overload situation, transmitting to the second apparatus a first request to apply the second periodicity when reporting the one or more measurement results.

In some example embodiments, the first apparatus further comprises means for in accordance with a determination that the first apparatus is in a non-overload situation, transmitting to the second apparatus a second request to resume applying the first periodicity when reporting the one or more measurement results.

In some example embodiments, the first apparatus further comprises means for transmitting an indication of at least one service of the second apparatus, the second periodicity being specific to the at least one service.

In some example embodiments, the second periodicity is a common periodicity shared among a plurality of services by the second apparatus.

In some example embodiments, wherein the indication of the second periodicity comprises at least one of the following: a value of the second periodicity, an offset value indicating a time difference between the second periodicity and the first periodicity, or a scale factor of the second periodicity relative to the first periodicity.

In some example embodiments, the second periodicity information is transmitted via a system information block or a radio resource control message.

In some example embodiments, the second periodicity is longer than the first periodicity.

In some example embodiments, the first periodicity is configured by a third apparatus, and wherein the third apparatus is a core network apparatus or an operation administration and maintenance apparatus.

In some example embodiments, the first apparatus is an access network apparatus, and the second apparatus is a terminal apparatus comprising the access stratum and an application layer.

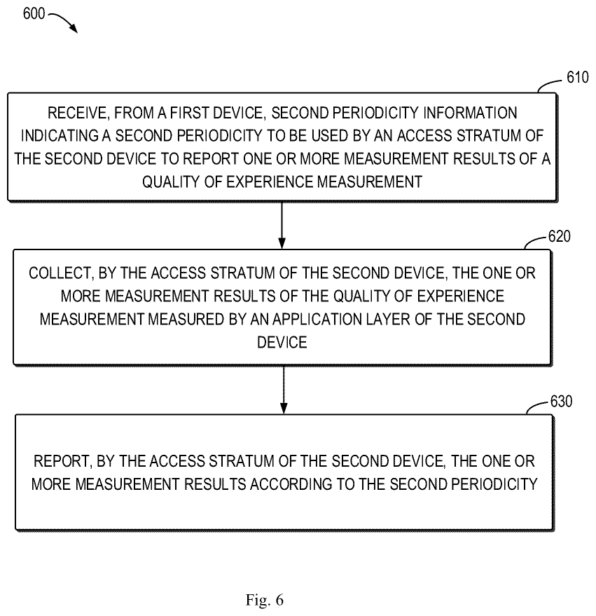

FIG. 6 shows a flowchart of an example method 600 implemented at a second device 220 in accordance with some example embodiments of the present disclosure. For the purpose of discussion, the method 600 will be described from the perspective of the first device 210 with respect to FIG. 2. It is to be understood that the method 600 may include additional blocks not shown and/or may omit some shown blocks, and the scope of the present disclosure is not limited in this regard.

At block 610, the second device 220 receives, at a second device 220 and from a first device 210, second periodicity information indicating a second periodicity to be used by an access stratum of the second device 220 to report one or more measurement results of a quality of experience measurement, the second periodicity configured based on a first periodicity used by the second device 220 to perform the quality of experience measurement.

At block 620, the second device 220 collects, by the access stratum of the second device 220, the one or more measurement results of the quality of experience measurement measured by an application layer of the second device 220.

At block 630, the second device 220 reports, by the access stratum of the second device 220, the one or more measurement results according to the second periodicity.

In some example embodiments, the second device 220 obtains the first periodicity; and transmits a message comprising first periodicity information indicating the first periodicity to the first device 210.

In some example embodiments, the second device 220 receives, from the first device 210, an application layer container used to configure parameters for the quality of experience measurement together with the second periodicity information.

In some example embodiments, the second device 220, reports, by the access stratum of the second device 220, the one or more measurement results according to the second periodicity in accordance with a determination that a condition for applying the second periodicity is met.

In some example embodiments, the second device 220 determines the condition for applying the second periodicity is met in response to at least one of the following: receiving the second periodicity information from the first device 210; receiving, from the first device 210, a first request to apply the second periodicity when reporting the one or more measurement results; or determining that the first device 210 is in an overload situation.

In some example embodiments, the second device 220 reports, by the access stratum of the second device 220, the one or more measurement results according to the first periodicity in accordance with a determination that a condition for resuming applying the first periodicity is met.

In some example embodiments, the second device 220 determines the condition for resuming applying the first periodicity is met in response to at least one of the following: receiving, from the first device 210, a second request to resume applying the first periodicity when reporting the one or more measurement results; or determining the first device 210 is in a non-overload situation.

In some example embodiments, the second device 220 starts a timer according to the second periodicity, appends each of the one or more measurement results to a measurement log, and reports the measurement log to the first device 210 in accordance with a determination that the timer is timeout.

In some example embodiments, the second device 220 receives, from the first device 210, an indication of at least one service of the second device 220, the second periodicity being specific to the at least one service. The access stratum of the second device 220 reports the one or more measurement results of at least one service according to the second periodicity.

In some example embodiments, the second periodicity is a common periodicity shared among a plurality of services by the second device 220. The second device 220 applies the second periodicity to a plurality of services, and reports, by the access stratum of the second device 220, the one or more measurement results of the plurality of services according to the second periodicity.

In some example embodiments, wherein the second periodicity information comprises at least one of the following: a value of the second periodicity, an offset value indicating a time difference between the second periodicity and the first periodicity, or a scale factor of the second periodicity relative to the first periodicity.

In some example embodiments, the second device 220 the second periodicity information is received via a system information block or a radio resource control message.

In some example embodiments, the second device 220 the second periodicity is longer than the first periodicity.

In some example embodiments, the second device 220 the first periodicity is configured by a third device 230, and wherein the third device 230 is a core network device or an operation administration and maintenance device

In some example embodiments, the first device 210 is an access network device, and the second device 220 is a terminal device comprising the access stratum and an application layer.

A second apparatus capable of performing the method 600 may comprise means for performing the respective operations of the method 600. The means may be implemented in any suitable form. For example, the means may be implemented in a circuitry or software module. The second apparatus may be implemented as or included in the second device 220.

In some example embodiments, the second apparatus comprises means for receiving, at a second apparatus and from a first apparatus, second periodicity information indicating a second periodicity to be used by an access stratum of the second apparatus to report one or more measurement results of a quality of experience measurement, the second periodicity configured based on a first periodicity used by the second apparatus to perform the quality of experience measurement; means for collecting, by the access stratum of the second apparatus, the one or more measurement results of the quality of experience measurement measured by an application layer of the second apparatus; and means for reporting, by the access stratum of the second apparatus, the one or more measurement results according to the second periodicity.

In some example embodiments, the second further apparatus comprises: means for obtaining the first periodicity; and means for transmitting a message comprising first periodicity information indicating the first periodicity to the first apparatus.

In some example embodiments, the second further apparatus comprises: means for receiving, from the first apparatus, an application layer container used to configure parameters for the quality of experience measurement together with the second periodicity information.

In some example embodiments, means for reporting the one or more measurement results according to the second periodicity comprises: means for in accordance with a determination that a condition for applying the second periodicity is met, reporting, by the access stratum of the second apparatus, the one or more measurement results according to the second periodicity.

In some example embodiments, the second further apparatus comprises: means for determining the condition for applying the second periodicity is met in response to at least one of the following: receiving the second periodicity information from the first apparatus;
receiving, from the first apparatus, a first request to apply the second periodicity when reporting the one or more measurement results; or determining that the first apparatus is in an overload situation.

In some example embodiments, the second further apparatus comprises: means for in accordance with a determination that a condition for resuming applying the first periodicity is met, report, by the access stratum of the second apparatus, the one or more measurement results according to the first periodicity.

In some example embodiments, the second further apparatus comprises: means for determine the condition for resuming applying the first periodicity is met in response to at least one of the following: receiving, from the first apparatus, a second request to resume applying the first periodicity when reporting the one or more measurement results; or determining the first apparatus is in a non-overload situation.

In some example embodiments, means for reporting the one or more measurement results according to the second periodicity comprises: means for starting a timer according to the second periodicity; means for appending each of the one or more measurement results to a measurement log; and means for in accordance with a determination that the timer is timeout, reporting the measurement log to the first apparatus.

In some example embodiments, the second apparatus further comprises: means for receiving, from the first apparatus, an indication of at least one service of the second apparatus, the second periodicity being specific to the at least one service; and means for reporting, by the access stratum of the second apparatus, the one or more measurement results of at least one service according to the second periodicity.

In some example embodiments, the second periodicity is a common periodicity shared among a plurality of services by the second apparatus. The second apparatus further comprises: means for applying the second periodicity to a plurality of services; and means for reporting, by the access stratum of the second apparatus, the one or more measurement results of the plurality of services according to the second periodicity.

In some example embodiments, the second periodicity information comprises at least one of the following: a value of the second periodicity, an offset value indicating a time difference between the second periodicity and the first periodicity, or a scale factor of the second periodicity relative to the first periodicity.

In some example embodiments, the second periodicity information is received via a system information block or a radio resource control message.

In some example embodiments, the second periodicity is longer than the first periodicity.

In some example embodiments, the first periodicity is configured by a third apparatus, and wherein the third apparatus is a core network apparatus or an operation administration and maintenance apparatus.

In some example embodiments, the first apparatus is an access network apparatus, and the second apparatus is a terminal apparatus comprising the access stratum and an application layer.

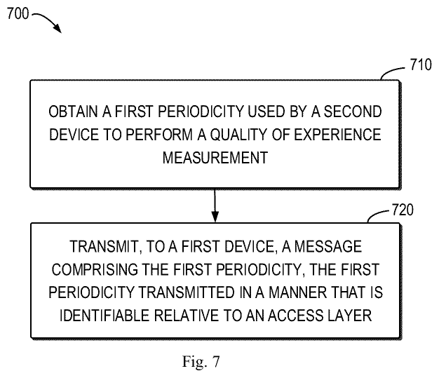

FIG. 7 shows a flowchart of an example method 700 implemented at a third device 230 in accordance with some example embodiments of the present disclosure. For the purpose of discussion, the method 700 will be described from the perspective of the first device 210 230 with respect to FIG. 2. It is to be understood that the method 700 may include additional blocks not shown and/or may omit some shown blocks, and the scope of the present disclosure is not limited in this regard.

At block 710, the third device 230 obtains, at a third device 230, a first periodicity used by a second device 220 to perform a quality of experience measurement.

At block 720, the third device 230 transmits, to a first device 210, a message comprising the first periodicity, the first periodicity transmitted in a manner that is identifiable relative to an access stratum.

In some example embodiments, the third device 230 is a core network device or an operation administration and maintenance device, the first device 210 is an access network device, and the second device 220 is a terminal device comprising the access stratum and an application layer.

A third apparatus capable of performing the method 700 may comprise means for performing the respective operations of the method 700. The means may be implemented in any suitable form. For example, the means may be implemented in a circuitry or software module. The third apparatus may be implemented as or included in the third device 230.

In some example embodiments, The third apparatus comprises means for obtaining, at a third apparatus, a first periodicity used by a second apparatus to perform a quality of experience measurement; and means for transmitting, to a first apparatus, a message comprising the first periodicity, the first periodicity transmitted in a manner that is identifiable relative to access stratum.

In some example embodiments, the third apparatus is a core network apparatus or an operation administration and maintenance apparatus, the first apparatus is an access network apparatus, and the second apparatus is a terminal apparatus comprising the access stratum and an application layer.

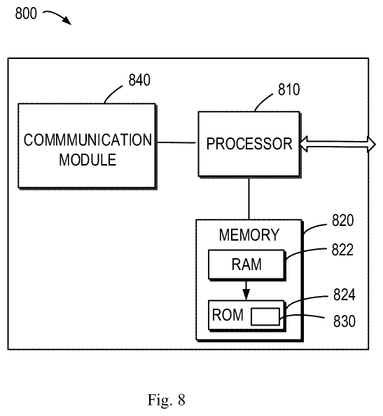

FIG. 8 is a simplified block diagram of a device 800 that is suitable for implementing embodiments of the present disclosure. The device 800 may be provided to implement a communication device, for example, the first device 210, the second device 220 and the third device 230 as shown in FIG. 2. As shown, the device 800 includes one or more processors 810, one or more memories 820 coupled to the processor 810, and one or more communication modules 840 (such as, transmitters and/or receivers) coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 3 to 7. The embodiments of the present disclosure may also be implemented by hardware or by a combination of software and hardware.

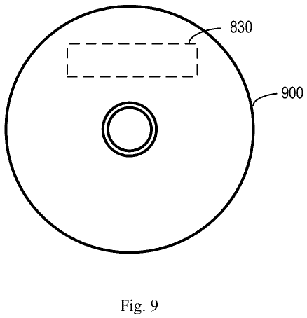

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 to 700 as described above with reference to FIGS. 5-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor; and
at least one memory including computer program code;
wherein the at least one memory and the computer program code are configured to, with the at least one processor, cause the terminal device to:
receive, by an access stratum of the terminal device from an access network device, first periodicity information together with second periodicity information, the first periodicity information indicating a first periodicity to be used by an application layer of the terminal device in reporting of quality of experience measurements for a service of the terminal device and the second periodicity information indicating a second periodicity that is configured by the access network device for the terminal device to report one or more measurement results of the quality of experience measurements of the service;
collect, by the terminal device, the one or more measurement results of the quality of experience measurements measured by the application layer of the terminal device; and
report the one or more measurement results according to the second periodicity.

2. The terminal device of claim 1, wherein the terminal device uses the second periodicity to transmit by the access stratum the one or more measurement results after receiving a request from the access network device.

3. The terminal device of claim 1, wherein the at least one memory and the computer program code are configured to, with the at least one processor, further cause the terminal device to:
receive, from the access network device, an application layer container used to configure parameters for the quality of experience measurements together with the second periodicity information, wherein the application layer container comprises the first periodicity information indicating the first periodicity.

4. The terminal device of claim 1, wherein the at least one memory and the computer program code are configured to, with the at least one processor, cause the terminal device to report the one or more measurement results according to the second periodicity by:
starting a timer according to the second periodicity;
appending each of the one or more measurement results to a measurement log; and
in accordance with a determination that the timer is timeout, reporting the measurement log to the access network device.

5. The terminal device of claim 1, wherein the at least one memory and the computer program code are configured to, with the at least one processor, further cause the terminal device to:
transmit, by the access stratum of the terminal device to the access network device, the one or more measurement results.

6. The terminal device of claim 1, wherein the second periodicity information is received via a radio resource control message.

7. The terminal device of claim 1, wherein the second periodicity information comprises at least one of the following:
a value of the second periodicity, or
a scale factor of the second periodicity relative to the first periodicity.

8. The terminal device of claim 1, wherein the at least one memory and the computer program code are configured to, with the at least one processor, further cause the terminal device to:
collect the one or more measurement results by the access stratum of the terminal device, and
transmit the one or more measurement results by the access stratum of the terminal device.

9. A method comprising:
receiving by an access stratum of a terminal device, from an access network device, first periodicity information together with second periodicity information, the first periodicity information indicating a first periodicity used by an application layer of the terminal device in reporting of quality of experience measurements for a service of the terminal device and the second periodicity information indicating a second periodicity that is configured by the access network device for the terminal device to report one or more measurement results of the quality of experience measurements of the service;
collecting, by the terminal device, the one or more measurement results of the quality of experience measurement measured by the application layer of the terminal device; and
reporting the one or more measurement results according to the second periodicity.

10. The method of claim 9, wherein the one or more measurement results are collected by the access stratum of the terminal device, and
wherein the one or more measurement results are transmitted by the access stratum of the terminal device.

11. The method of claim 9, further comprising:
receiving, from the access network device, an application layer container used to configure parameters for the quality of experience measurements together with the second periodicity information, wherein the application layer container comprises first periodicity information indicating a first periodicity.

12. The method of claim 9, wherein reporting the one or more measurement results according to the second periodicity comprises:
starting a timer according to the second periodicity;
appending each of the one or more measurement results to a measurement log; and
in accordance with a determination that the timer is timeout, reporting the measurement log to the access network device.

13. The method of claim 9, further comprising:
transmitting, by the access stratum of the terminal device to the access network device, the one or more measurement results.

14. The method of claim 9, wherein the second periodicity information is received via a radio resource control message.

15. The method of claim 14, wherein the second periodicity information comprises at least one of the following:
a value of the second periodicity, or
a scale factor of the second periodicity relative to the first periodicity.

16. A non-transitory computer readable medium comprising a computer program thereon, the computer program when executed by a processor of a terminal device, causing the terminal device to:
receive by an access stratum of the terminal device from an access network device, first periodicity information together with second periodicity information, the first periodicity information indicating a first periodicity to be used by an application layer of the terminal device in reporting of quality of experience measurements for a service of the terminal device and the second periodicity information indicating a second periodicity that is configured by the access network device for the terminal device to report one or more measurement results of the quality of experience measurements of the service;
collect, by the terminal device, the one or more measurement results of the quality of experience measurements measured by the application layer of the terminal device; and
report the one or more measurement results according to the second periodicity.

17. The non-transitory computer readable medium of claim 16, wherein the access stratum of the terminal device is further caused to use the second periodicity to transmit the one or more measurement results after receiving a request from the access network device.

18. The non-transitory computer readable medium of claim 16, wherein the terminal device is further caused to:
receive, from the access network device, an application layer container used to configure parameters for the quality of experience measurements together with the second periodicity information, wherein the application layer container comprises the first periodicity information indicating the first periodicity.

19. The non-transitory computer readable medium of claim 16, wherein the access stratum of the terminal device is further caused to:
transmit, to the access network device, the one or more measurement results.

20. The non-transitory computer readable medium of claim 16, wherein the second periodicity information is received via a radio resource control message.

21. The non-transitory computer readable medium of claim 16, wherein the second periodicity information comprises at least one of the following:
a value of the second periodicity, or
a scale factor of the second periodicity relative to the first periodicity.
